(19) United States
(12) Patent Application Publication
(10) Pub. No.: US 2013/0003497 A1
(43) Pub. Date: Jan. 3, 2013

(54) STREAMER CABLE FOR USE IN MARINE SEISMIC EXPLORATION AND METHOD FOR REDUCING NOISE GENERATION IN MARINE SEISMIC EXPLORATION

(75) Inventor: Thomas ELBOTH, Oslo (NO)

(73) Assignee: Fugro Norway AS, Oslo (NO)

(21) Appl. No.: 13/171,195

(22) Filed: Jun. 28, 2011

(51) Int. Cl. G01V 1/38

(52) U.S. Cl. 367/20

(57) ABSTRACT

The present invention relates to a streamer cable for use in marine seismic exploration. Further, a method for reducing noise generation in marine seismic exploration is described, as well as a method for the preparation of the said seismic cables.

### BRIEF SUMMARY OF THE INVENTION

The present invention relates to an improved marine seismic streamer cable and a method for noise reduction in the frequency range below 20 Hz in connection with marine seismic data acquisition.

### BACKGROUND OF THE INVENTION

Marine seismic acquisition is normally conducted by axially towing flexible streamer cables in the ocean. These cables are populated with sensors (for instance hydrophones), on which pressure recordings are made from subsurface reflections of acoustic energy originating from a pressure source (air guns). In this connection it should be noted that the term “sensor element” when used in the present description and claims refers to a device inside a streamer cable that is used to detect subsurface reflections. This will often be in the form of a hydrophone, but it can also be in the form of a geophone, an accelerometer/velocity sensor or similar equipment suitable for picking up seismic data. A large number of such recordings are used to build up an image of the subsurface. In a seismic operation streamer cables with a typical diameter of 5 cm and length of up to 10 km are used.

The relative motion of a streamer through the ocean creates a turbulent boundary layer (TBL) that surrounds the cable. Noise generated within this TBL significantly degrades the quality of collected data.

Seismic subsurface reflection data are normally limited to the 0-250 Hz range. For the seismic industry, this is where the signal-to-noise ratio (SNR) primarily needs to be improved. Examples of noise sources within this frequency range are wave motions from subsurface waves, wakes from the towing vessel, and external currents that cause pressure fluctuations and rattling on streamer cables. Other noise sources are tugging caused by swells that abruptly force the towing vessel to different towing speeds, and the presence of seismic equipment such as module cans and depth controllers along the streamer cable. Different types of ocean ambient noise that propagates over long distances also exist. Examples are seismic interference, noise from oceanic traffic and noise from marine creatures. In the 1990's significant contributions to the understanding of noise generation mechanisms on fluid filled seismic streamers were made.

Since then, the seismic industry has focused on systematically improving streamer system technology to reduce the effects of many of the identified sources of noise. With few exceptions, most of the work towards these improvements have not focused on noise originating from the turbulent boundary layer (TBL). However, it has recently been shown (see Elboth et al. “Flow and swell noise in marine seismic data”, Geophysics 74(2), Q17-Q25 (2009)) that on modern seismic streamer cables TBL noise is often significant. For frequencies below 20 Hz it is often the dominating source of noise. To reduce noise levels further the TBL noises thus have to be addressed.

It is thus an object of the present invention to reduce the level of noise in connection with seismic streamers in the frequency range below 20 Hz by modifying the turbulent boundary layer.

Friction in fluids is manifested through the phenomenon of drag, i.e. the force required to move an object through a fluid or move a fluid through a device.

Much effort has gone into developing surfaces that reduce drag. Bubbles, riblets and compliant walls are a few examples of approaches that have been evaluated. A special class of materials that have recently emerged are materials called superhydrophobic surface materials. These materials enhance the mobility of drops by reducing their contact-angle hysteresis and reduce drag in both laminar and turbulent flows. Superhydrophobic surfaces have contact angles of water droplets exceeding 150° and the roll off angle is less than 10°. This is referred to as the Lotus effect, since the effect was first observed on the leaves of lotus plant. On a macroscopic scale, a superhydrophobic surface will have non-zero slip velocity, and have recently been shown to reduced surface drag both for laminar and turbulent flows (see for instance C. Henoch, T. N. Krupenkin, P. Kolodner, J. A. Taylor, M. S. Hodes and A. M. Lyons, “Turbulent drag reduction using superhydrophobic surfaces”, 3^{rd} AIAA Flow Control Conference (2006).)

It has now surprisingly been found that by providing the streamer cable with a superhydrophobic surface, at least in the area of the hydrophones, it is possible to significantly reduce the noise generation in connection with marine seismic exploration, in particular in the frequency range below 20 Hz.

The present invention thus relates to a streamer cable for use in marine seismic acquisition, comprising pressure sensors (hydrophones) dispersed along the length of the cable, arranged to provide low noise in the frequency range below 20 Hz, whereby the surface of the streamer cable, at least in the areas surrounding the hydrophones, is highly hydrophobic.

The present invention further provides a method for reducing noise generated in the frequency range below 20 Hz in marine seismic exploration using seismic streamer cables with pressure sensors (for instance hydrophones) dispersed along the length of the streamer cables, whereby the streamer cables are provided with a highly hydrophobic surface, at least in the areas surrounding the sensor elements.

In the case that only the areas surrounding the sensor elements are covered with highly hydrophobic material it will be efficient to cover the area of approximately 0.5 meter upstream to approximately 0.1 meter downstream from the sensor element.

### BRIEF DESCRIPTION OF THE DRAWINGS

Below, the present invention will be described in greater detail with reference to the enclosed drawing, wherein:

FIG. 1 shows a scanning electron microscope (SEM) image of a silicon surface coated with a coating material to make the surface highly hydrophobic;

FIG. 2 shows the measured difference in drag between two 25 m long streamer cables towed at 6 knots in the ocean, where one of the cables was coated with a highly hydrophobic material, and the other was uncoated;

FIG. 3, Taken from a Re_{τ}=395 DNS computer simulation of flow noise generation from turbulent fluid flow: Top figure: shows variation of ensemble average first invariant of Tᵢⱼ tensor (solid) across a channel, where one boundary was superhydrophobic while the other side had a normal no-slip boundary, Bottom figure: shows ensemble average rms pressure (solid) and the ensemble average velocity (stapled) across the channel;

FIG. 4 shows a comparison of the magnitude of the Tᵢⱼ tensor components from the wall and into the centre of the Re_{τ}=395 DNS channel;

FIG. 5 shows how the relative reduction in rms noise level develops with time for the streamer in the ocean that was coated with a SHS coat;

FIG. 6 is a comparison of instantaneous far field pressure (flow noise) distribution outside the no-slip (left) and the SHS-slip (right) boundary. The data is derived from the acoustic computations using the Re_{τ}=395 DNS channel;

FIG. 7 shows linear plots of the normalized noise level as a function of frequency; and

FIG. 8 shows logarithmic plots of the normalized noise level as a function of frequency; the data in the two latter plots are taken from measurements on a real seismic cable in the ocean.

### DETAILED DESCRIPTION OF THE INVENTION

In connection with the present invention, two different approaches have been followed in order to quantify the effects of a highly hydrophobic surface on flow noise generation. The first is in the form of full-scale measurements on seismic streamer cables in the ocean, where a highly hydrophobic coating material was applied on part of a seismic streamer. The second approach is based on an analysis of a direct numerical simulation (DNS) of a fully developed channel flow. In this channel a normal no-slip condition was imposed on one wall, while the opposite wall was modelled as a superhydrophobic surface (SHS) by imposing slip and no-slip as a regular pattern. The imposition of such a mixed wall boundary condition constitutes a viable method to model a superhydrophobic surface.

The DNS approach is inherently limited to low/moderate Reynolds numbers due to the requirements of a fully resolved (spatially and temporary) simulation of the Navier-Stokes equations. Limited computing resources are generally what imposes this restriction. DNS data thus contains all the spatial and temporal details, but at moderate to low Reynolds number. Measured data are at the correct Reynolds number, but it contains much less details. They are also affected by the noise and other uncertainties. Despite the Reynolds number difference, the combination of a DNS and full-scale measurements is useful in order to gain a physical understanding of SHS on flow noise generation.

### Seismic Experiment

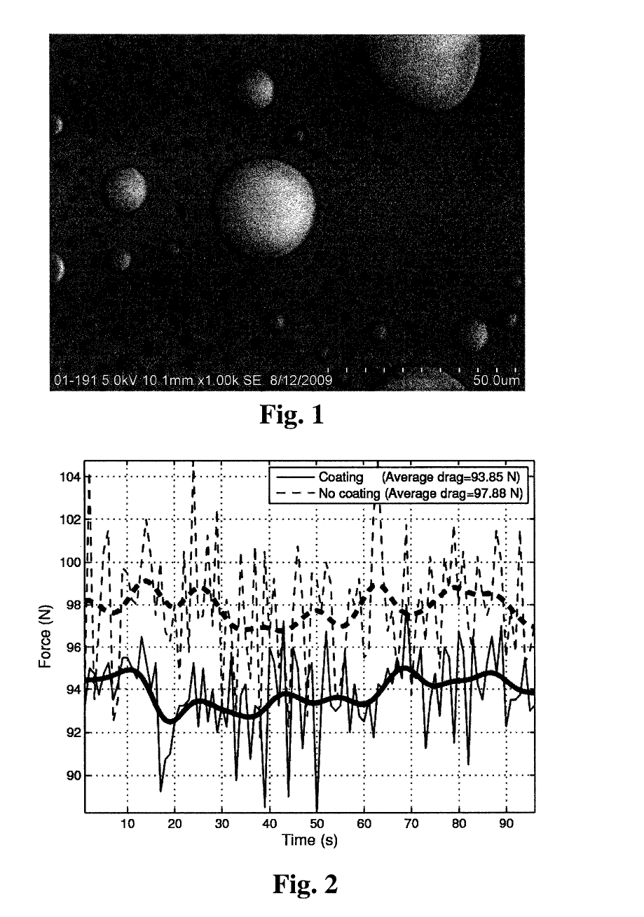

A number of approaches to produce highly hydrophobic surfaces have been described in the literature (cf. for instance M. Ma and R. M. Hill “Superhydrophobic surfaces”, Current Opinion in Colloid & Interphase Science 11, 193-202 (2006)). A convenient and inexpensive way to make a surface hydrophobic is to apply a suitable coating material. The SHS material used in this experiment is a product produced by the company Percenta AG, consisting of a silane blend mixed with isopropanol and ethanol, and marketed under the name “2 Components Anti Fouling Boats K1” and “2 Components Anti Fouling Boats K2”. The K1 component comprises the active ingredients and the K2 component constitutes the solvent/diluent. The two components are mixed immediately before use. This fluid was sprayed onto the surface where it forms a surface pattern corresponding to the one shown in FIG. 1. According to the manufacturer, the coat does not contain any materials that are harmful to the environment.

The first test was to apply this coating material to a 25 m long seismic streamer cable made of polyurethane, and measure how it affected the drag in an ocean environment. The results from this initial test are shown in FIG. 2, where a drag reduction of approximately 4% with SHS can be observed. In this figure the thin lines show individual measurements, while the thick lines are smoothed. One measurement was taken each second and the error of the measuring probe used was <0.1 Newton. During the experiment, metal weights were added to both the coated and uncoated streamer cable in order to keep them submerged. Theses weights did not contribute to the overall drag. However, none of the weights had a SHS coating, which means that the measured 4% drag reduction is probably an underestimation. Also tested was a third cable on which a surface structure was machined in the streamwise direction by sandpaper to give surface roughness of about 100 μm. No coating material was applied on this streamer. The result was a 5% increase in drag compared to the smooth untreated streamer cable.

These results may be compared with particle image velocimetry (PIV) measurements which indicated up to 50% drag reduction on a precisely manufactured regular patterned SHS at relatively low Reynolds numbers (cf. S. Gogte, P. Vorobieff, R. Truesdell, A. M. Li, F. van Swol, P. Shah and C. J. Brinker, “Effective slip on textured superhydrophobic surfaces”, Physics of Fluids 17, 051701 (2005)).

The commercial coating used was subsequently applied on parts of a seismic streamer cables used for exploration on a seismic vessel. During data acquisition, these cables were kept approximately 7 m below the surface, and the vessel velocity was 5 knots. All data was sampled at 2 ms, and a 3 Hz low cut filter was applied to avoid swell noise contamination.

From the acquired data, the root-mean squared (rms) noise level was computed, and the noise level between coated and un-coated parts of the streamer section was compared.

### Numerical Simulation

Flow noise is generated by turbulent flow fluctuations that propagate along the streamer surface with a velocity just below the towing speed. It is known in the art that flow noise generation is expressed by the Lighthill inhomogeneous wave equation, which is derived without approximations from the Navier-Stokes equations. It states that the acoustic pressure fluctuations (noise) in media is described by

$$\frac{1}{{c}_{0}^{2}} \frac{{\partial }^{2} p}{\partial {t}^{2}} - \frac{{\partial }^{2} p}{\partial {x}_{i}^{2}} = \frac{{\partial }^{2} ( {T}_{ij} )}{\partial {x}_{i} \partial {x}_{j}}$$

where Tᵢⱼ=ρuᵢuⱼ−σᵢⱼ+(p−c₀²ρ)δᵢⱼ, c₀ denotes local speed of sound, p(xᵢ, t) is the instantaneous pressure and ρ is the density of the fluid. Towed seismic streamers operate in a high Reynolds number flow environment. Viscous effects, σᵢⱼ are therefore usually neglected. Furthermore, it can be assumed that the acoustic energy is much smaller that the turbulent kinetic energy if the flow. The feedback from the acoustic field to the flow field is therefore negligible. Consequently, for towed streamer cables the momentum flow density ρ₀uᵢuⱼ, where i, jε{1, 2, 3}

is the dominating source in the above equation. A simplified Lighthill equation can be written as

$$\frac{1}{{c}_{0}^{2}} \frac{{\partial }^{2} p}{\partial {t}^{2}} - \frac{{\partial }^{2} p}{\partial {x}_{i}^{2}} = {ρ}_{0} \frac{{\partial }^{2} ( {u}_{i} {u}_{j} )}{\partial {x}_{i} \partial {x}_{j}}$$

Here ρ₀ denotes the fluid density, which is considered constant, approximately incompressible flow. This second equation can be solved numerically provided the second derivative of the tensor uᵢuⱼ is known.

The numerical simulation is also based upon a Re_{τ}=395 simulation of fully developed plane turbulent channel flow. (See, “Direct numerical simulations of turbulent flows over superhydrophobic surfaces”, MARTELL et. Al, Journal of Fluid Mechanics, Volume 620, February 2009, pp 31-41)

Slip is implemented through a no-shear condition. In the simulation the spanwise width of the slip area is 30 μm which experimentally have been found to be a suitable size in order to represent the microscopic structure of a SHS.

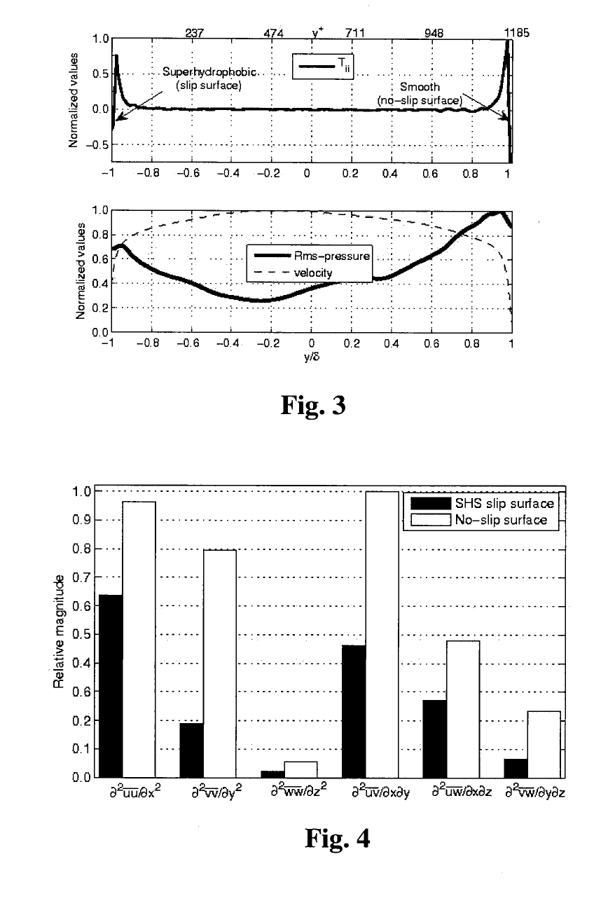

Effects of the SHS are quantified in FIG. 3, which shows some ensemble averaged quantities across the DNS channel. The top figure shows the first invariants of the Tᵢⱼ tensor. This physically represents the turbulent kinetic energy. The bottom figure shows how the rms pressure p varies. Both these quantities are significantly reduced close to the SHS compared to the normal smooth no-slip surface. The stapled line in the bottom figure shows the ensemble average velocity across the channel. It should be noticed that on the left (SHS) side, the (average) velocity does not approach zero at the boundary. T₁₁ only seems to be significant at a dimensionless wall distance y⁺=yu*/v between 0 and 100. Here y denotes wall distance, u* approx. 0.04 U₀ is the friction velocity, U₀ represents the free-stream velocity and v denotes the kinematic viscosity. This coincides with the area in which the Reynold stresses, and the turbulence production peak in boundary layer flows. In normal coordinates, for a seismic streamer, y⁺ approx. 100 corresponds to y approx. 1 cm. This gives an indication of how close to a moving object flow noise production takes place.

Turbulence in a boundary layer is generated when an on-coming flow suddenly is decelerated to satisfy the no-slip boundary condition. In this process energy is transformed from the mean flow Uᵢ to the turbulent field uᵢ′ by the action of the of the local velocity gradient (shear). The presence of a slip at the boundary, with a corresponding reduction in the shear, will reduce the turbulence intensity and wall friction, while the mean velocity across the channel will increase. This can be quantified in a low Reynolds number flow from the DNS data. FIG. 4 is taken from a numerical simulation of a low Reynolds number flow. It shows the relative magnitudes of each component δ²( u̅ᵢ̅u̅ⱼ̅)/δxᵢδxⱼ the Tij-tensor. The 6 independent tensor components are shown along the x-axis. From this figure it is clear that the magnitude of the acoustic source term is reduced close to a SHS compared to a normal no-slip surface. The reduction is especially large for the components that have derivatives in the wall normal direction. This is probably related to the increased anisotropy of the flow close to the slip boundary, where the wall-normal flow component appears to have been suppressed.

### Results

### Seismic Experiment

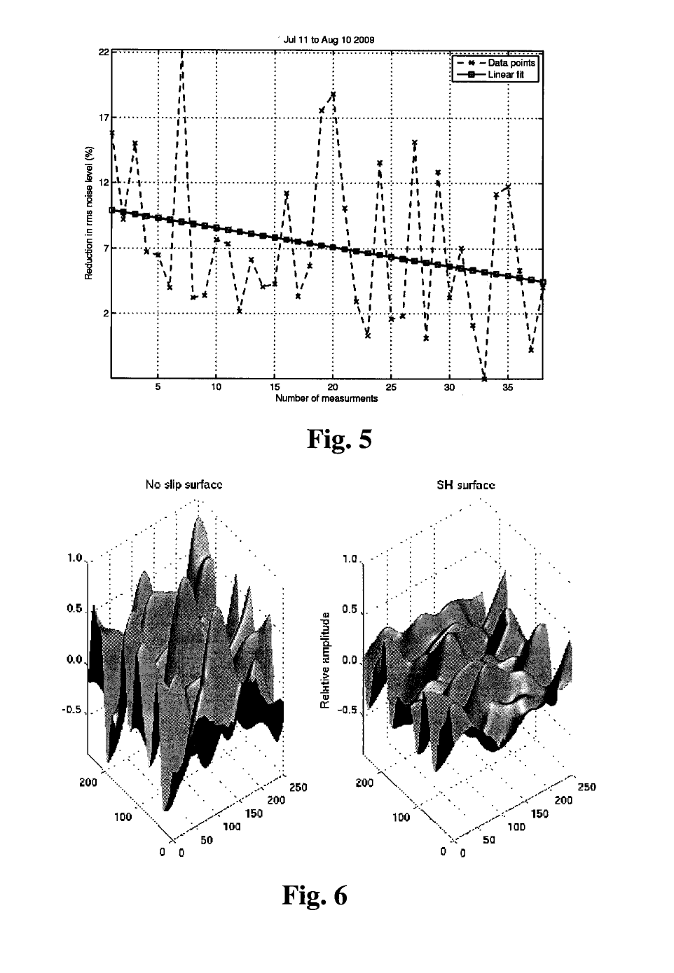

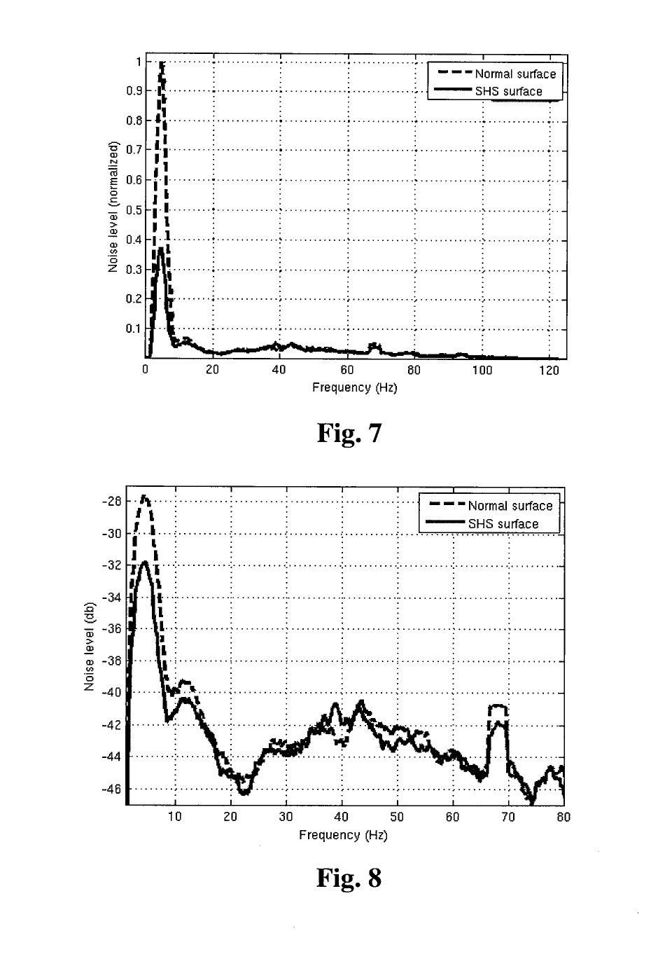

FIG. 5 shows how the rms noise level on a seismic streamer was affected by a SHS coat. The reduction was computed by comparing a number of 30 s noise records acquired in July and August 2009 by a seismic vessel operating in the Barents Sea. The data shows that the SHS coat initially reduced the rms noise level by more than 10%. In the same figure the least squares linear fit indicates that the effect of the SHS coating is reduced with time, this is probably because this particular coating was washed off. FIGS. 7 and 8 compare the average frequency content of the flow noise on streamer sections with and without a SHS. One can clearly observe that for frequencies below approx. 20 Hz the noise level is significantly reduced.

In a similar test with a coated streamer section in the ocean off French Guiana in October and November 2009, no noise reducing effect of the coating material was detectable when the streamer had been in the water for about one month.

### Numerical Experiment

FIG. 6 compares the noise level (pressure) near a SHS surface and a normal no-slip surface. It can clearly be observed that the amplitudes are significantly reduced close to the SHS surface. To compare the simulation results with real seismic noise records it is necessary to model the effects of the pressure fluctuations on a hydrophone membrane. A hydrophone membrane has been modelled by averaging the pressure over a 2 by 1 cm area in a time series, outside both the SHS slip and the normal no-slip boundary. The difference in temporal rms between these two simulated hydrophones was almost 60%, which really illustrates the effects a SHS can have on the flow noise level.

### Frequency Content

In both the seismic experiment and in the simulation data it was observed that on average, the SHS-coating data has slightly lower amplitudes below 20 Hz compared to the no-slip data. For frequencies above 20 Hz no significant differences were observed.

FIG. 7 shows a linear plot of the normalized noise level as a function of frequency. The logarithmic plot shown in FIG. 8 reveals some more detail in the low frequency range. The measurements have been performed on a seismic cable with and without SHS surface treatment. From FIG. 7 it is obvious that in the frequency range below 10 Hz the SHS surface treatment results in a considerable reduction of the noise level. FIG. 8 shows that also in the range 10-20 Hz noise reduction is achieved. As indicated above, below 20 Hz the noise originating in the turbulent boundary layer surrounding the streamer cables, is one of the dominant sources of noise. A reduction of the noise level in this frequency range is therefore of considerable importance.

### CONCLUSION

Measurements have been performed showing that a highly hydrophobic surface coat can reduce the drag around seismic streamer cables in an ocean environment by about 5%. In addition it has, for the first time, been shown that the same coating reduced the rms flow noise level on a streamer section by approximately 10%. A 10% reduction in noise level might not seem impressive. It should be remembered, however, that seismic streamer technology has been fine-tuned over many decades to improve the SNR. The additional advantage offered by the SHS will therefore be valuable.

In the literature superhydrophobic surfaces with a distinct pattern of ribs or posts along the flow direction has been described. Unfortunately, such patterns are difficult and expensive to manufacture, and it is probably impractical to cover hundreds of km of seismic streamer cable with a precisely manufactured SHS pattern. For industrial applications, a highly hydrophobic coating material that can be sprayed on is more practical. A spraying process does create a suboptimal random surface pattern. However, the ease and cost of applying is a strong argument in favour of a simple coat.

The simulations carried out, using a nearly ideal SHS, did give a flow noise reduction of almost 60%. Such a large reduction is probably difficult to achieve in an industrial application.

In spite of theses shortcomings, the present invention has shown that highly hydrophobic surfaces have a significant flow noise reduction potential.

What is claimed as new and desired to be protected by Letters Patent of the United States is:

1. A flexible streamer cable for use in marine seismic exploration, providing low noise in the frequency range below 20 Hz, containing sensor elements dispersed along the length of the cable, characterized in that the surface of the streamer, at least in the areas surrounding the sensor elements, is covered by highly hydrophobic material displaying water contact angles close to or above 120°.

2. The flexible streamer cable according to claim 1, characterized in that the streamer is covered by highly hydrophobic material over its entire length.

3. The flexible streamer cable according to claim 1, characterized in that only the areas of the streamer surrounding the sensor elements is covered by highly hydrophobic material.

4. The flexible streamer cable according to any one of the preceding claims, characterized in that the highly hydrophobic material is selected from the group consisting of polytetrafluoroethylene (PTFE, Teflon), polydimethylsiloxane (PDMS), compounds comprising silane groups or mixtures thereof.

5. A method for reducing noise generation in the frequency range below 20 Hz in marine seismic exploration using flexible seismic cables with sensors elements dispersed along the length of the cables, characterized in that the surface of the streamer, at least in the areas surrounding the sensores, is covered by a highly hydrophobic material which displays water contact angles close to or above 120°.

6. The method according to claim 6, characterized in that the highly hydrophobic surface is provided on the entire length of the streamer cable.

7. The method according to claim 6, characterized in that the highly hydrophobic surface is provided only on the areas surrounding the sensors.
